(19) United States
(12) Patent Application Publication
(10) Pub. No.: US 2024/0051288 A1
(43) Pub. Date: Feb. 15, 2024

(54) SYSTEM AND METHOD FOR DIRECT TO GARMENT PRINTING

(71) Applicant: Smoove Creations Inc., La Grange, TX (US)

(72) Inventors: Isaiah Kelly, La Grange, KY (US); Blaise Ghering, Union, KY (US); Lucas Williamson, Bethel, OH (US); Nathan Maggard, Cincinnati, OH (US); Jeremy Sanders, St. Louis, MO (US)

(21) Appl. No.: 18/232,083

(22) Filed: Aug. 9, 2023

Related U.S. Application Data
(60) Provisional application No. 63/396,505, filed on Aug. 9, 2022.

(51) Int. Cl. B41F 17/00; B41J 3/407; G06F 3/12

(52) U.S. Cl. CPC B41F 17/003; B41J 3/4078; G06F 3/1205; G06F 3/126

(57) ABSTRACT

A system providing a design interface that displays a virtual model of an article to be designed by a user such as a shoe. The user may apply colors and images to the article, and may scale, rotate, and position images using the interface. The interface displays the custom design throughout and may also provide warnings or simulated results where the custom design may be influenced by equipment limitations of a direct to garment printer (“DTG”) on which it will be printed. A completed design is serialized and saved and may be used to create a print dataset that may be printed to a DTG printer or site and that is usable to configure and execute a print job for the design. Print jobs may be aided by the use of specialized covers and platens to prevent overspray, isolate movement, and provide a flat print surface for irregularly.

### CROSS-REFERENCE TO RELATED APPLICATIONS

The present application claims the priority to U.S. Provisional Patent Application Ser. No. 63/396,505 filed on Aug. 9, 2022, the disclosure of which is hereby incorporated by reference in its entirety.

### FIELD

The disclosed technology pertains to a system for direct to garment printing on footwear and other manufactured goods.

### BACKGROUND

Direct to garment (“DTG”) printing has become an increasingly popular alternative to screen printing when creating custom shirts and other clothing. Since screen printing requires substantial preparation of physical materials for each unique design it is inefficient for producing a single article or a handful of articles of clothing. Conversely, the preparation required for DTG printing is much less substantial, and primarily includes the conversion of a design to a print path used by the DTG printer to determine the sequence and characteristics of ink spray (e.g., position, color, magnitude) rather than in the production of physical materials. As a result, DTG printing can be advantageous for production of small batches of custom articles.

Even with advancements in DTG technology the range of garments and articles that can be printed is relatively narrow. Many conventional DTG printers are configured solely for printing on shirts, pants, or other thin cloth articles that can be readily arranged on a print surface to provide a smooth and flat surface on which the DTG printer sprays ink. Some DTG printers also provide platens that are adapted for certain articles, such as a short-sleeve shirt platen that receives and holds a short-sleeve shirt to isolate movement or shifting of the article during printing and to provide a flat print surface for targeted portions of the article (e.g., the front-chest portion of a t-shirt may be pulled taught against the flat print surface of the platen and held in place to prevent stretching or shifting of the cloth during printing).

However, conventional DTG printing is focused primarily or entirely on printing on flattened cloth articles due to factors such as the difficulty of printing on articles having an irregular shape or semi-rigid structures, such as shoes, hats, backpacks, and the like. As a result, there are a very limited number of options for software and equipment for DTG printing to some non-clothing articles, and the options that are available consist of very basic adaptations to enable DTG printers that are specialized for flat cloth articles to print on other irregular and/or structural articles (e.g., such as basic hat platens on which a portion of a hat may be flattened and isolated). While such adaptations may be adequate for some uses, there are a number of disadvantages due to the underlying equipment being specialized for printing to flat cloth articles (e.g., time and difficulty of positioning the article, inability to print on different sides of article, inability to print along curved surfaces of article).

What is needed, therefore, is an improved system for DTG printing on articles that are irregularly shaped or have structural portions.

### BRIEF DESCRIPTION OF THE DRAWINGS

The drawings and detailed description that follow are intended to be merely illustrative and are not intended to limit the scope of the disclosure as contemplated by the inventors.

FIG. 1 is a schematic diagram of an exemplary system configured to provide DTG printing for irregular articles.

FIG. 2 is a flowchart of a set of high-level steps that a system could perform to provide DTG printing on irregular articles.

FIG. 3 is a flowchart of a set of steps that a system could perform to create a serialized dataset based on a user design.

FIG. 4 is a flowchart of a set of steps that a system could perform to provide a user design interface.

FIG. 5 is a screenshot of an exemplary user design interface.

FIG. 6A is a front perspective view of a print cover usable with an irregular article during printing.

FIG. 6B is a front perspective view of the print cover of FIG. 6A fitted onto a shoe.

FIG. 6C is a front perspective view of an eyelet plug.

FIG. 6D is a side elevation view of a shoe with a set of the eyelet plugs of FIG. 6C.

FIG. 7A is a front perspective view of a platen usable with an irregular article during printing.

FIG. 7B is a front perspective view of a shoe fitted to the platen of FIG. 7A, with dashed lines overlaid to indicate the position of the platen within the shoe.

FIG. 8A is a front perspective view of an alternate platen usable with an irregular article during printing.

FIG. 8B is a front perspective view of a shoe fitted to the platen of FIG. 8A, with dashed lines overlaid to indicate the position of the platen within the shoe.

FIG. 9A is a front perspective view of a two-sided platen usable with an irregular article during printing.

FIG. 9B is a front perspective view of an adjustable platen usable with an irregular article during printing.

FIG. 10 is a schematic diagram of a DTG printing system configured to detect a position and orientation of a target article.

FIG. 11 is a flowchart of a set of steps that a system could perform to detect a position and orientation of a target article.

### DETAILED DESCRIPTION

The inventors have conceived of novel technology that, for the purpose of illustration, is disclosed herein as applied in the context of direct to garment printing. While the disclosed applications of the inventors' technology satisfy a long-felt but unmet need in the art of direct to garment printing, it should be understood that the inventors' technology is not limited to being implemented in the precise manners set forth herein, but could be implemented in other manners without undue experimentation by those of ordinary skill in the art in light of this disclosure. Accordingly, the examples set forth herein should be understood as being illustrative only and should not be treated as limiting.

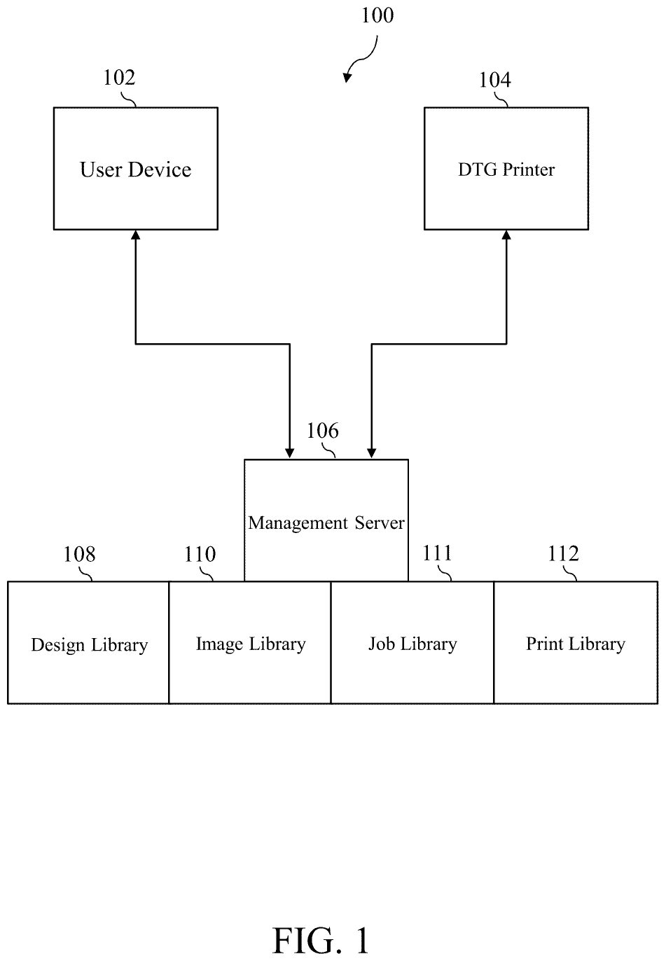

Turning now to the figures, FIG. 1 shows a schematic diagram of an exemplary system (100) configured to enable DTG printing of irregular articles, including providing a user interface for designing custom articles, creating print paths and print job datasets, and providing data and instructions for initiating print jobs. Features and functions of the system (100) allow users to design and create articles with varying colors, images, materials, and other characteristics, and to have those articles printed using their own DTG equipment or that of a third party.

The system (100) includes a management server (106) configured to provide interfaces and features to user devices and to manage, update, and access a design library (108), an image library (110), a job library (111), and a print library (112). The management server (106) may be one or more physical servers, virtual servers, cloud servers, or other server environments, with individual servers comprising one or more processors, memories, communication devices and other components, as will be apparent to those of ordinary skill in the art in light of this disclosure.

The design library (108) may be a database table, schema, or other structure storing a dataset of design information, which may include files or data describing various images, colors, target articles (e.g., models and characteristics distinct types or designs of shoes, hats, or other irregular articles). As an example, the design library (108) may store reference numbers, reference keys, PDFs, or other files describing such features of a design, or may store data objects that are manually configured or parsed from such files or may store both.

The image library (110) may be a database schema, table, or other structure storing a dataset of image information, which may include files or data describing various images, such as an image file, an image reference ID or key, a design ID, an image size, a numerical representation of any rotational data, a 3-D image position, a 2-D image position, a design layer, an image direction and an origin point, as well as other characteristics that may be optionally associated with a particular image or design.

The job library (111) may be a database schema, table, or other structure storing a dataset of print job information, which may include files or data describing various print jobs, such as a design key, a user-1D for the designer, an order-ID, a printer-ID, an order date, and an order status, as well as other characteristics that may be optionally associated with a particular job.

The print library (112) may be a database schema, table, or other structure storing a dataset of print information, which may include files or data describing various orders, such as a design key, a size, and a gender, as well as other characteristics that may be optionally associated with a particular order.

It should be understood that the particular data included in the various libraries (108, 110, 111, 112) may vary by implementation, and the above are merely descriptions of exemplary data that may be included. As an example, the contents of the libraries (108, 110, 111, 112) may be stored in a single database or other repository and may be spread or represented across a number of tables therein. As another example, images, models, and other files or documents may be stored in file repositories that are linked to or referenced by a database.

User devices (102) in communication with the management server may include computers, laptops, smartphones, tablets, and other computing devices including processors, memories, communication devices, displays, user input devices, and other components as will be apparent to those of ordinary skill in the art in light of this disclosure. User devices (102) may be usable to display and interact with design interfaces and thus interact with the management server (106) to view and design unique articles and possibly other information in the libraries managed by the management server (106).

User devices (102) may access interfaces and information from the management server (106) in numerous ways and may include, for example, configuring a software application (e.g., a mobile application), accessing a website, or accessing another data channel or interface. In some implementations, separate websites or applications may be provided for varying device types. In some implementations, a single application or website may be provided to all user devices, with varying functionality and features being determined based upon a user's identification, login credentials, or other information. Such variations and others will be apparent to those of ordinary skill in the art in light of this disclosure.

A design from a user device (102) may be configured to be used by a DTG printer (104) to print custom images or colors onto an irregular article such as a pair of shoes. This may include configuring the design information such that the design information accounts for any limitations in the equipment (104) to be used in making or printing the custom design. The reconfiguration of the design information may be completed automatically or manually. The same is true for the reconfiguration of the DTG printer (104). The DTG printer (104) may be a conventional DTG printer of varying capabilities that is capable of receiving an irregular article such as a shoe or hat at a work surface and executing a print path in order to apply ink on one or more sides of the article. Use of a DTG printer (104) with a flexibly positionable print head (e.g., six degree of freedom within the three dimensional area above the work surface) may be advantageous, in that multiple sides of an irregular article may be printed on without requiring that the article be repositioned on the work surface or refitted to a platen (e.g., a flexibly positionable print head may be positioned to print on an outer exterior surface, inner exterior surface, back, and tongue of a shoe without repositioning between each). The DTG printer (104) may be, for example, locally available to the user of the user device (102) or may be remotely operated by a third party, and in any case may receive print paths, assets, and other data related to a print dataset via the management server (106) and/or directly via the user device (102) or another locally connected device or memory.

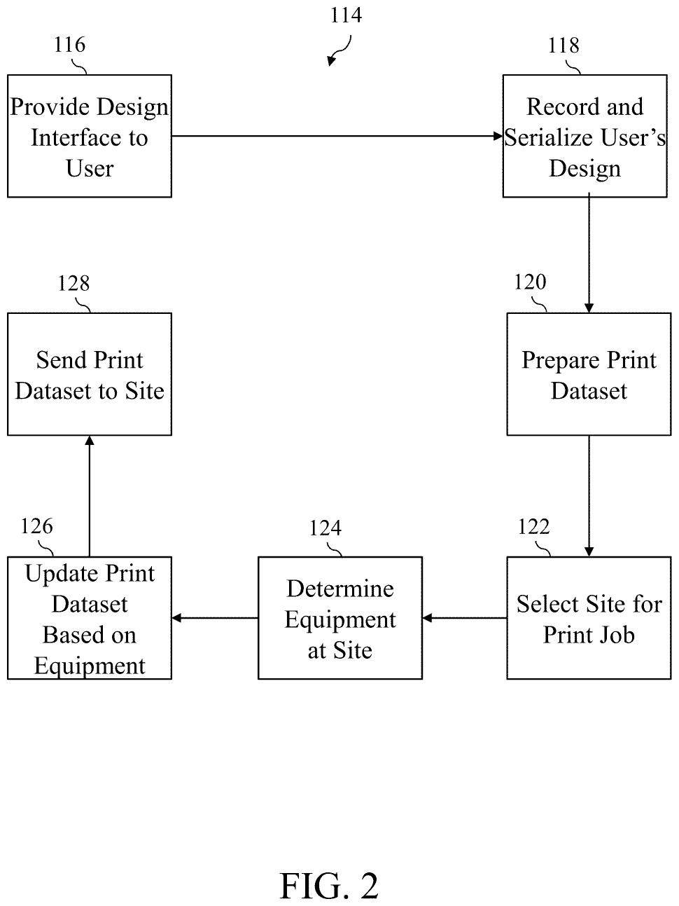

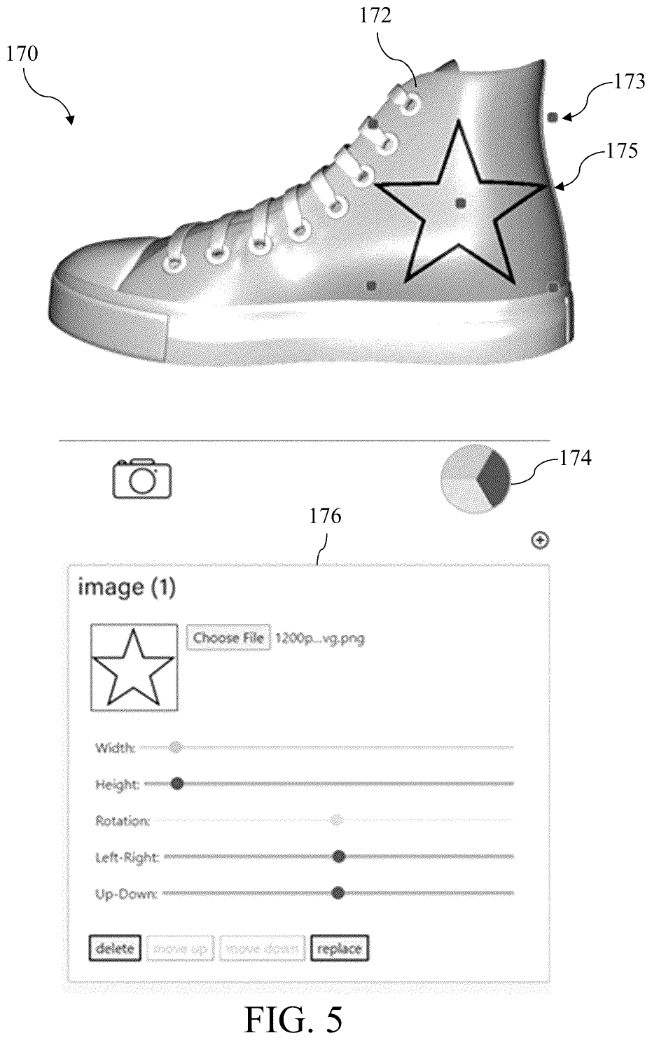

Turning now to FIG. 2, that figure shows a flowchart of a set of high-level steps (114) that a system could perform to create custom articles. The system (100) may provide a design interface to a user (116) such that a user may manipulate a virtual article, such as a model of a shoe, and add an image or color to the virtual article and reposition any added image on the virtual article. As one example, this could include a user uploading or importing an image or decal to a user interface with a virtual shoe and repositioning this image on the virtual shoe (e.g., such as illustrated by FIG. 5). Once a user adds, removes, or otherwise changes a design element through the provided design interface and saves or completes the design, this change may be saved to the design library (108) or another data repository. For example, when a user adds an image to a design, and the design change data has been serialized (118), the serialized data will be saved to the design library and made available for reference by the management server (106).

Serialization (118) of the design may include, for example, normalization of the data (e.g., to account for variances in user devices, browsers, or other software used to access the design interface), enforcement of certain restrictions or limitations (e.g., down-scaling or up-scaling of images or other assets so that they correspond to the resolution of supported DTG printers (104)), and encoding of the design into a standardized dataset or object that may be transmitted to DTG printers (104) or other devices (e.g., such as a set of commas, separated values, or data containers that indicate characteristics of the design such as the target article type and size, identity, position, and orientation of images and other assets placed on the design, and indications of colors, materials, or other selections applied to particular portions of the design).

A serialized design may be selected by a user to be printed, and a print dataset may be created (120) from a serialized (118) dataset and stored in the job library (111) or another repository. While the serialized (118) dataset includes an encoded description of the complete design, it may not be configured to be usable directly by a DTG printer (104). When preparing (120) the print dataset, the system may produce print path and configuration data based on the serialized dataset and based upon other factors such as the capabilities of the DTG printer (104). For example, in some implementations the system may prepare (120) the print dataset by producing a print-path based on the serialized (118) design dataset, and/or may prepare a configuration dataset based on the particular DTG printer (104) that the job is being sent to. Varying printers may have optimal configurations for a particular print job based on the selected colors and images, and based on the capabilities of the printer (e.g., print resolution, spray volume and distance, and print head speed may vary by printer, and may be automatically optimized for each job based upon pre-configured settings or rules specific to that printer, printer type, or manufacturer).

In some implementations, the print dataset (120) may be configured to be transmitted directly to the DTG printer (104) and to automatically configure the printer, and provide the print path for the print job, such that a user need only manually position the article and initiate the print job. In some implementations, the print dataset (120) may be transmitted to a system or device associated with the DTG printer (104), and a portion of the dataset may be transmitted to the DTG printer (104) to provide the build path while other portions describe manual configurations or other steps to be performed by the user prior to, during, and after the print job.

With a job configured (120) and associated with a particular design, the job may then be assigned to a particular DTG printer (104). This may be based on the geographic location of the printer in relation to the user or customer, based on a user selection or preference, or based on the equipment needed to print the unique design or image. Once a print job is assigned to a DTG printer (122), the management server (106) may determine the specifics of the assigned printer's equipment and limitations (124) and use such information to prepare the print dataset (120) as described. After receiving the equipment information, or based upon previously received information, the print dataset may be reconfigured to optimize the quality of the job (126), as has been described. The system may then provide (128) the print dataset to the assigned site and/or DTG printer (104), which may include transmitting some or all of the print dataset directly to the DTG printer (104), or to a device associated with the site or printer.

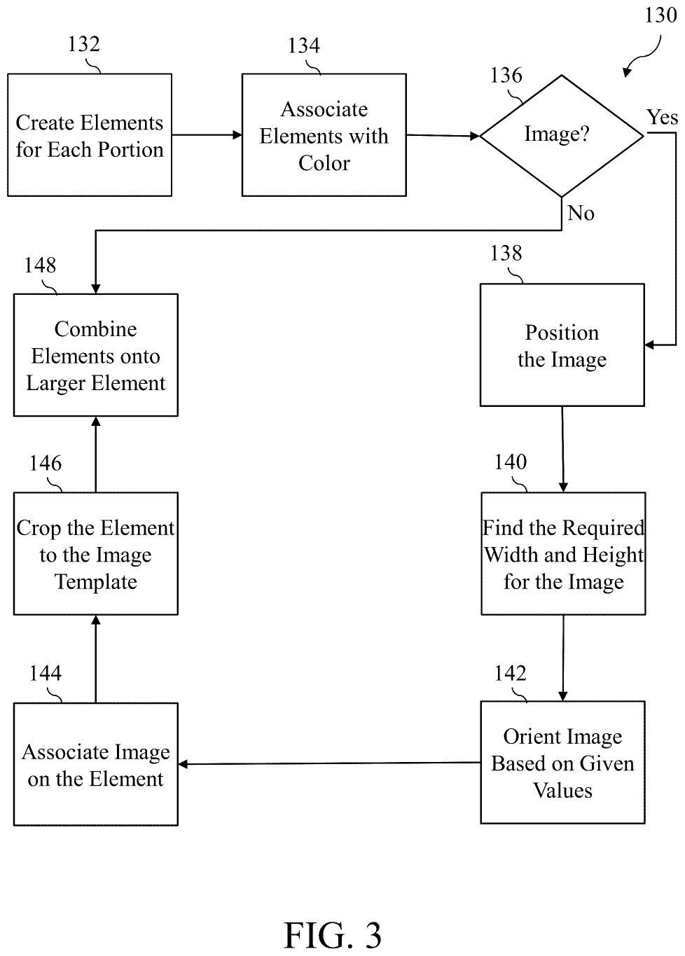

Turning now to FIG. 3, a flowchart of a set of steps (130) that a system could perform to create a serialized and/or normalized dataset from a user design is shown. The system (100) may create elements for each portion of the designed article (132), such as an HTML5 Canvas element or other object or representation (e.g., such as a comma separated value descriptor). The elements may then be configured such that the individual elements or portions are associated with a selected color. For example, a Canvas element may be covered in a color by filling the pixels within that Canvas element with the specified color, or an attribute of a non-displayable object may be associated with an identifier for the color. After the elements are associated with a color (134), an image may be associated with the design if selected by the user (136). If the custom design has one or more images, each image may be added to its own element and positioned corresponding to the user's design (138). For example, where serializing the design into Canvas elements or other objects, this may include creating a new image object and setting values or attributes based upon the user selected position. The image may be scaled (140) based on the user selected design, which may include associating a scale or resolution with the image objects or elements, and/or may include upscaling or downscaling the image resolution for compatibility with a subsequent print job. The image may also be oriented (142) based on the user selected orientation of the image, which may include associating an orientation with the image object or element or may include modifying the image itself to rotate to the desired orientation.

Once finalized, the image may be associated with the element(s) upon which it is placed (144) and saved. This may also include cropping (146) the image based on the design article. For example, the template could be a transparent portion of a Canvas element in the shape of the piece of the article to be printed on and a white portion covering the areas that are not to be printed on. The template helps prevent the DTG printer from over spraying onto unintended areas of the article, and cuts of portions of an image that may extend into unprintable portions of the article (e.g., such as rubber or plastic portions of a shoe). Last, the individual elements for each piece of the article are combined into one larger element (148) or object. For example, when serializing into a Canvas element, an element for either side of the article would be placed opposite the other on a larger Canvas element. As another example, when serializing into another object or dataset, this may include compiling a number of individual objects or elements into a single comma separated value file or stream, markup language file (e.g., XML, HTML), or data interchange format (e.g., JSON).

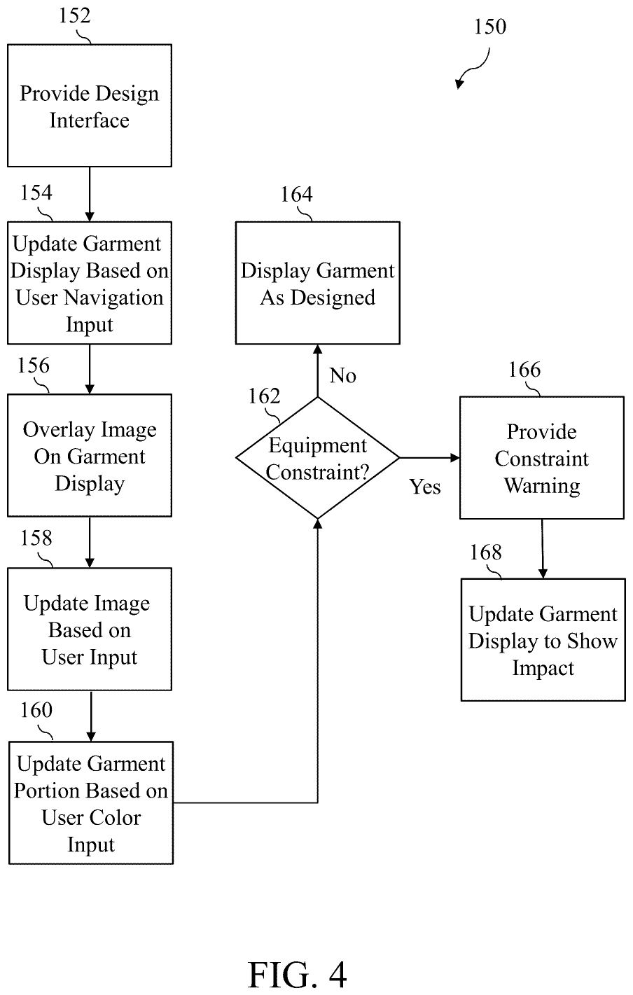

Turning now to FIG. 4, a flowchart of a set of actions (150) that a system could perform to provide (152) a design interface to a user is shown. The design interface may provide a virtual model of an article to use as a template on which the user may apply design elements. Once the user accesses the interface, the user may navigate (154) the display of the user interface to view the article template, which may include rotating the model article to better see the design or view the design at varying angles or may include scrolling to or zooming in on certain portions of the article. This may include freely rotating a three-dimensional model of the article in virtual space, rotating to pre-set views of the article (e.g., front, sides, back). In some implementations, the article may be displayed as a three-dimensional model, or a series of flattened images of different portions of a three-dimensional model, or both. In some implementations, the article model may be displayed singularly, or may be displayed in multiples (e.g., a single shoe may be displayed from multiple angles simultaneously, or two shoes from a pair of designed shoes may be displayed simultaneously).

The user may also add one or more images to the model article to be integrated as a part of the user's design (156). Once an image is added, the user may configure the image (158), including rotating, repositioning, or scaling the image on the model article, each such operation corresponding to similar steps described in the context of FIG. 3, but performed by the user via the user interface during the design phase. In some implementations, the system may manage and create Canvas elements or other objects to serve as both the user interface display of the article and the final serialized dataset describing the object (e.g., the Canvas elements used to display the article may be saved as Canvas elements, or may be converted into others objects or markup language that corresponds to Canvas elements).

The user may also add color to any of the individual pieces of the model article (160). For example, referencing FIG. 5, a user may select a color via a color selection tab on the design interface and choose a side of the article to cover with the chosen color. This may be reflected on the design interface by filling the side of the article digitally with the chosen color, and such color selections may be associated with the serialized dataset as has been described above.

In some implementations, while using the design interface the system may determine some information about the user and/or information relating to DTG printer (104) equipment available for the user's design. This may include identifying the user's geographic location and nearby print locations based on the user's account, IP address-based geolocation, or a user's self-location, for example. As another example, this may include determining different types of DTG printers (104) that are available or assigning a particular DTG printer (104) or type of DTG printer (104) to a particular in-progress design regardless of the user's location or other user specific information (e.g., such as assigning randomly, or based upon availability, or other supply chain considerations). As another example, the user may finalize their design and proceed to a point where they are purchasing an article based on the design and are assigned given the option to select a location or equipment type to service the purchase.

Regardless of the manner in determining the target DTG Printer (104), the system may have some indication of the type of DTG printer (104) that the design is intended for and may be pre-configured based on the type of DTG printer (104) to apply certain constraint-based design visualizations to the in-progress article design via the user interface. Where the system determines there is no constraint (162), the system may display (164) the designed garment on the user interface as it was designed by the user without modification.

Where the system determines that equipment constraints are present (162) and will have an impact on the user's in-progress design, the system may provide (166) a constraint warning and update (168) the display of the garment on the design interface to reflect and show the impact of the constraint. As an example, where the user selects a color to apply to a portion of a shoe, and the system determines that the color is outside of a range supported by a particular DTG printer (104) to which the design will be assigned, the system may indicate (166) to the user that the color is out of range, and may update (168) the display of the shoe on the user interface to reflect a similar color that is within range of that DTG printers (104) capabilities. As another example, where the user adds an image to the design and positions the image at certain portions of the shoe that are close to non-printable areas (e.g., metal or plastic lace eyelets, rubber sole portions, rubber or plastic toe portions), the system may determine that the target DTG printer (104) is limited in the extent, resolution, or quality of spray near those non-printable areas, and may warn the user (166) via an alert on the design interface and update (168) the interface to reflect the likely outcome of the constraint based on the images current position (e.g., this may include applying a gradient fading or other decrease in quality of the printed image as it nears the non-printable area). In this manner, the system gives the user the ability to visualize the likely outcome of their in-progress design, and allows the user to modify the design (e.g., selecting a different color, moving the image further away from non-printable areas) or select a different DTG printer (104) that is not subject to the determined constraints (162).

FIG. 5 shows a screenshot of an exemplary user design interface (170). The design interface (170) includes a visualization of an article (172), shown as a three-dimensional model of a particular type of shoe to which DTG printing may be performed using the system. An image (175) selected by a user is displayed on a particular portion of the shoe where it has been placed by the user, and additional controls (173) are displayed relative to the image and may be interacted with by the user to move, rotate, scale, or otherwise arrange the image (175) relative to the displayed virtual article (172).

Other user controls may include a color wheel (174) or other color control by which a user can select particular portions of the article (172) to apply color to, such as by applying a color to an entire portion of the article (172) (e.g., applying a selected color to the entire tongue, right side, or left side of the shoe), or by applying a color using a cursor, paintbrush, or other software tool (e.g., applying free-form color to the shoe based upon the user inputs). A picture control (176) may also be included by which a user can provide, select, or upload one or more images, and that may include additional controls to modify characteristics of the images such as sliders, menus, buttons, or selections to modify the image size, orientation, x-y position, color, x-y inversion, or other characteristics.

As a user arranges images on the article (172), the system may modify the image as has been described above (e.g., to reflect constraints of the target article and/or target DTG printer (104)) and may modify the display of the image based on the article (172) itself. For example, rather than reflecting the image as a two dimensional overlay upon a three-dimensional article, the user interface may be configured to overlay the two-dimensional image onto the three-dimensional article at the position that is selected by the user, such that the two-dimensional image becomes a three-dimensional image or layer conforming to the surface of the three-dimensional article (172) (e.g., portions of the 2D image may appear at varying scale depending upon the relative depth from the viewer, or portions of the 2D image may not be visible where they wrap around to an un-displayed side of the 3D article).

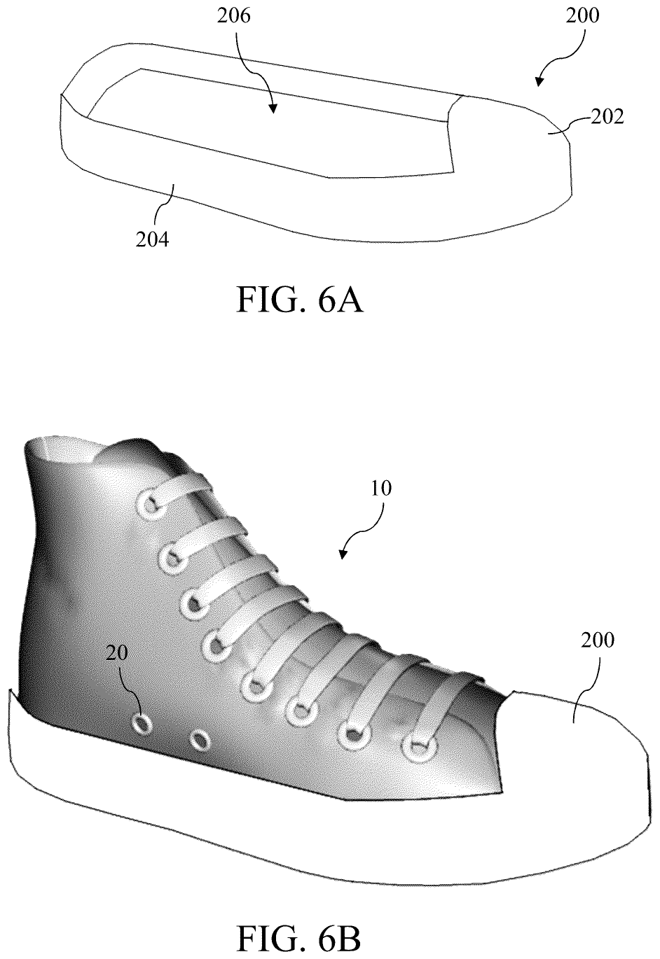

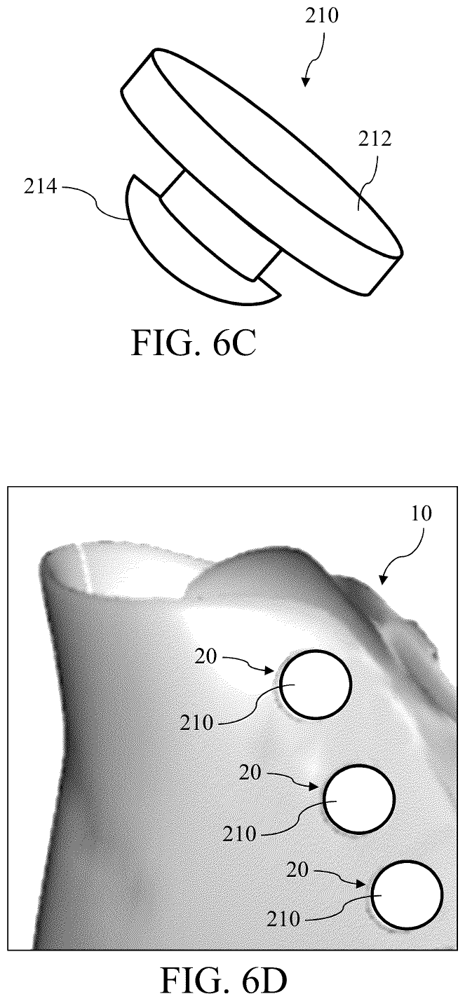

Implementations of the disclosed system and software may advantageously include additional features and devices beyond those described above. FIGS. 6A through 6D show variations on cover devices that may be used during DTG printing of an article if required. While those figures illustrate the target article as a shoe (10), it should be understood that the disclosed concepts may be readily applied to other articles such as hats, bags, smartphones cases, and other garments and articles. FIG. 6A shows a cover (200) for DTG printing on a shoe (10). The cover (200) may be comprised of a flexible substantially impermeable material such as a rubber, silicon, plastic, or other suitable material. To accommodate the shown shoe (10), the cover (200) includes a toe portion (202) and a sidewall (204) comprised of a thin flexible material and defining a hollow interior (206) that accommodates the shoe (10) and covers non-cloth and/or non-printable portions of the shoe (10), such as the plastic or rubber sidewall and toe of the shoe (10). The cover (200) may include a bottom portion and may be stretched over the shoe (10) during printing, or may be open on the bottom such that the shoe (10) is passed through the bottom and held on the shoe (10) by the toe portion (202) and sidewall (204), as illustrated in FIG. 6B. Use of the cover (200) with the shoe (10) during DTG printing prevents overspray onto non-printable portions of the shoe (10), and the shape and coverage provided by the cover (200) may correspond for each shoe type to the design interface provided to the user (e.g., portions of article covered by the cover (200) will be non-printable on the design interface, such that a user cannot arrange colors and/or images on the covered portions). Although not shown, in some embodiments, the shoe may also have a non-printable portion running along the upper back heel of the shoe. In such embodiments, a vinyl cover portion will also protect this portion of the shoe.

FIG. 6C shows an example of an eyelet plug (210) that may be used with a shoe (10). As illustrated in FIG. 6D, eyelet plugs (210) may be placed in each eyelet (20) of the shoe (10) during DTG printing to prevent overspray onto metal or plastic surrounding the eyelets (20). The eyelet plug (210) includes a face portion (212) having a size and shape corresponding to and exceeding the eyelet (20), such that when placed within the eyelet (20), the eyelet (20) is entirely covered by the face portion (212). The face portion (212) may be flat on both sides or may include a hollowed rear portion with an extended edge or sidewall that seals against the cloth of the shoe (10) and covers any sidewall portion of the eyelet (20). The eyelet plug (210) also includes a tab (214) formed of a flexible rubber or plastic and adapted to compress and snugly pass through the eyelet (20), whereby the tab (214) expands to its original shape and holds the eyelet plug (210) within the eyelet (20) until a substantial force is used to remove the plug (210). In this manner, the eyelet plugs (210) may be used to protect the eyelets (20) from overspray and are held in place and prevented from accidental removal as may occur during printing and/or positioning of the shoe (10). Alternately, the eyelet plug (210) may be comprised of a rigid tab (214) that is screwed onto the face portion rather than through a flexible fit or friction fit. Variations of the eyelet plugs (210) may also be used to aid in fitting a platen to the shoe (10), and to aid a DTG printing system in registering the shoe (10) within a work area, as will be described in more detail below.

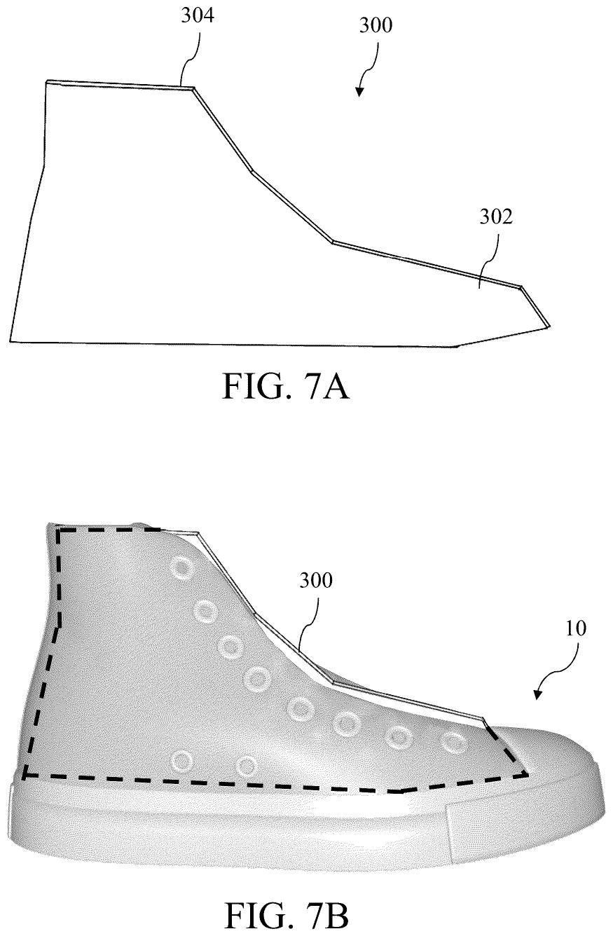

FIG. 7A shows an exemplary platen (300) for use with shoes such as the shoe (10) illustrated above, while FIG. 7B shows the platen (300) installed within the shoe (10), with obscured portions of the platen (300) illustrated as dashed lines within the shoe (10). The platen (300) of FIG. 7A provides a thin rigid substrate upon which a printable portion of the shoe (10) may be stretched over to provide a flat and regular print surface. While platens for t-shirts and other thin cloth garments primarily serve a function of isolating movement of the garment, platens for irregular garments such as the platen (300) advantageously provide a flat rigid surface upon which portions of irregularly shaped articles may be stretched, clamped, or otherwise fitted so that the DTG printer (104) does not need to compensate for varying depths or curvature of the print surface. The platen (300) includes a body (302) having a thin edge (304) shaped and sized to be inserted into and brace against an interior sole of the shoe and force the corresponding cloth portions of the shoe to contour to a flat face of the body (302).

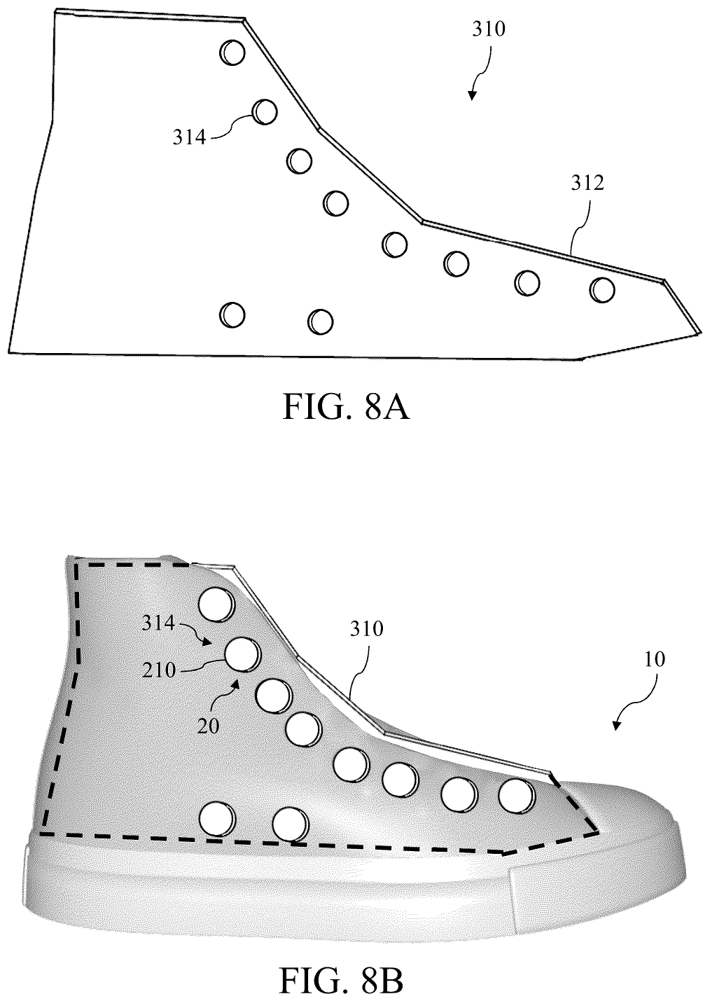

FIG. 8A shows an alternate platen (310) for use with the shoe (10). The platen (310) includes a series of eyelet holes (314) passing through the body (312) of the platen (310) whose size, position, and number corresponds to the eyelets (20) of a corresponding shoe (10). When positioning the platen (310) in the shoe (10), each eyelet (20) of the shoe may be aligned with a corresponding eyelet hole (314) of the platen and an eyelet plug (210) or other fastener passed through both to fix the shoe to the platen (310), as illustrated in FIG. 8B. As an alternative to the eyelet holes (314), the platen (310) may include a set of extending tabs or hooks fixed to its flat face that may be passed through the eyelets (20) of the shoe.

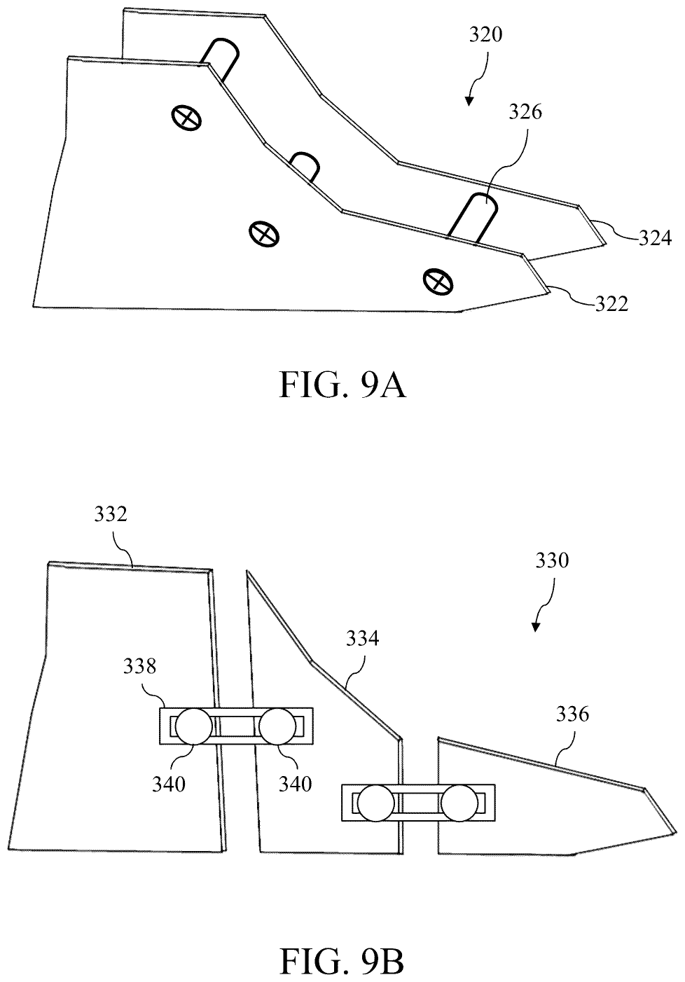

Other variations on shoe platens and their features exist and may be combined with some or all of the preceding embodiments. As an example, FIG. 9A shows a dual platen (320) comprising a first platen (322) and second platen (324) that are coupled to each other via a set of dividers (326). The dual platen (320) may be inserted into a shoe as has been illustrated, and each side of the shoe may be simultaneously affixed to the platen. The dividers (326) may be comprised of a post and bolt configuration that allows for the device to assembled at varying widths to accommodate shoes of varying widths, and the dual platen (320) may be modified to include some or all of the features of other platens disclosed herein (e.g., eyelet hooks or holes for affixing the shoe to the platen face, eyelet plugs, size extension, etc.).

As another example, FIG. 9B shows an extendable platen (330) that allows for a length adjustment to accommodate varying sizes of shoe. The extendable platen (300) is comprised of a first (332), second (334), and third portion (336) that are each coupled to an adjacent portion by a sliding adjustment bar (338) and fasteners (340), such that the overall length of the platen (330) may be adjusted by loosening the fasteners (340) such each platen portion may be slid within the adjustment bar (338) to a desired location and the fasteners (340) refastened to hold the portions in place. In varying implementations, length adjustment may be achieved by means other than a combination of a sliding bar and fasteners, such as by including an adjustment bar having a series of spaced apart holes instead of a sliding bar, or other means. As with prior examples, the extendable platen (300) may be combined with some or all of the features of other platens (e.g., dual platens, eyelet hooks or holes, eyelet plugs, etc.).

FIG. 12 shows yet another example of a platen (500). Platen (500) has a body (502) with a first side (504a), a second side (504b), and a lip (506). As can be seen in FIG. 13, the first side (504a) is positioned within a first shoe (10a) and the second side (504b) is positioned within a second shoe (10b) of a matching pair of shoes (10). The lip (506) is positioned against the outer heel of each shoe (10a) and (10b) to keep said shoes tight on each side of the platen (500). It is also contemplated that platen (500) can include sightlines (SL) that correspond to various different sized shoes (10) to assist with correct placement of the shoes (10) on the platen (500).

Although not shown, it is also contemplated that platen (500) can include a series of eyelet holes passing through the body (502) of the platen (500) whose size, position, and number corresponds to the eyelets (20) of a corresponding shoe (10). In such an embodiment, both the first side (504a) and the second side (504b) would have a series of eyelet holes. When positioning the platen (500) in the shoe (10), each eyelet (20) of the shoe may be aligned with a corresponding eyelet hole of the platen (500) and an eyelet plug (210) or other fastener can pass through both to fix the shoe (10) to the platen (500), in a similar manner to what is shown in FIG. 8B. As an alternative to the eyelet holes, it is also contemplated that the platen (500) may include a set of extending tabs or hooks fixed to its flat face that may be passed through the eyelets (20) of the shoe (10).

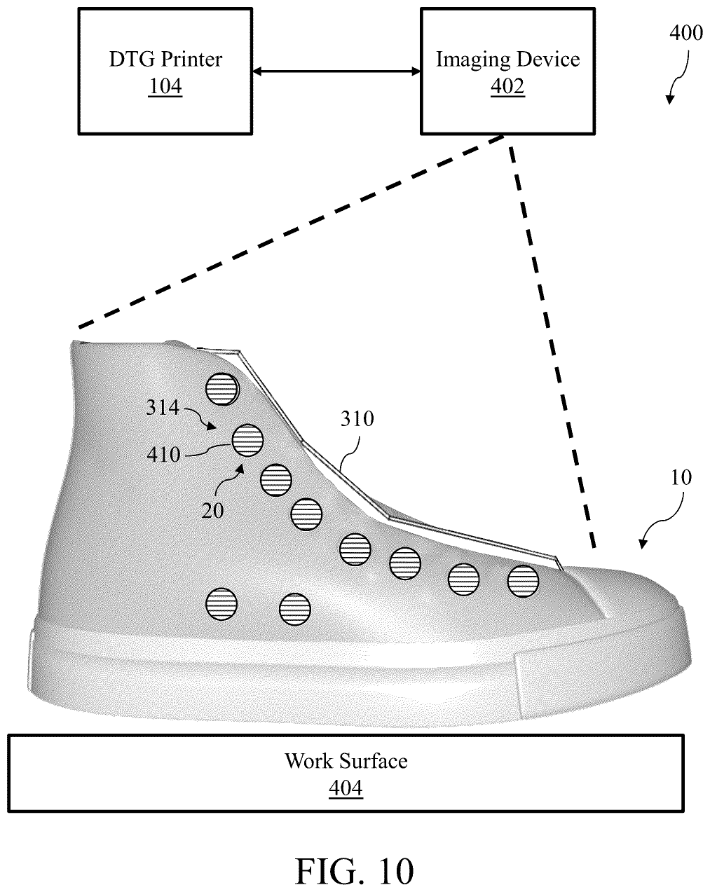

FIG. 10 shows a schematic diagram of a DTG printing system (400). The DTG printing system (400) includes an imaging device (402) such as a camera or other optical sensor in communication with the DTG printer (104). The imaging device (402) is positioned such that its field of view captures the work surface (404) or other print area upon or within which the DTG printer (104) is capable of printing upon an article such as the shoe (10). The shoe (10) is configured with the above disclosed alternate platen (310), and a series of optical eyelet plugs (410) similar to the eyelet plug (210) of FIG. 6C are positioned within the eyelets (20) of the shoe. The optical eyelet plugs (410) have a front portion comprising an optical element such as a reflective surface, high contrast surface (e.g., bright white, bright green, bright orange), or optically encoded surface (e.g., a QR code, barcode, or other optically encoded element).

After the shoe (10) is arranged on the work surface (404), the imaging device (402) is configured to capture images of the work surface and identify the optical eyelet plugs (410) within the image. The appearance of the optical eyelet plugs (410) within the image data, relative to a known and/or fixed position of the imaging device (402) field of view may be used to determine and register the position and/or orientation of the shoe (10) on the work surface (404), as will be described in more detail below. While use of optical eyelet plugs (410) provides an advantageous reference point for machine vision imaging and registration of the shoe's (10) position and orientation, it should be understood that they are not required and that the shoe's eyelets (20) or other features may be identified using machine vision techniques without requiring any eyelet covers or plugs, whether optical or otherwise.

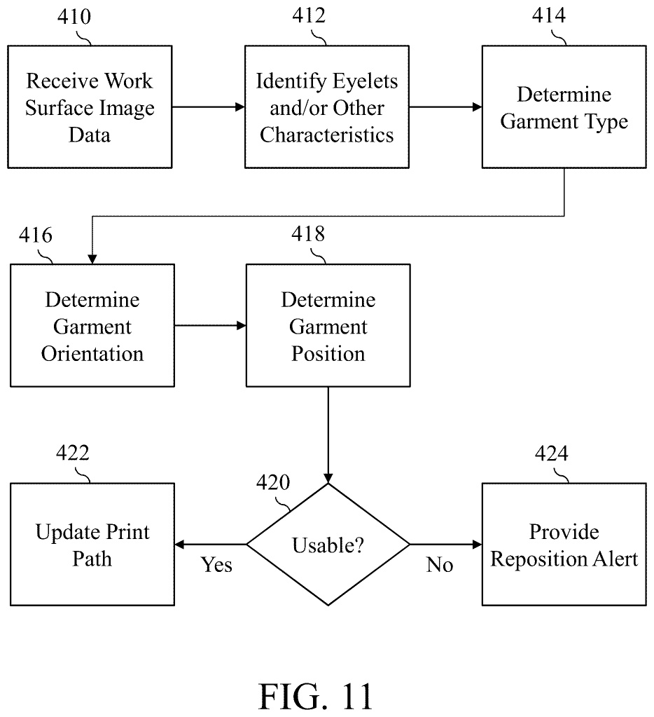

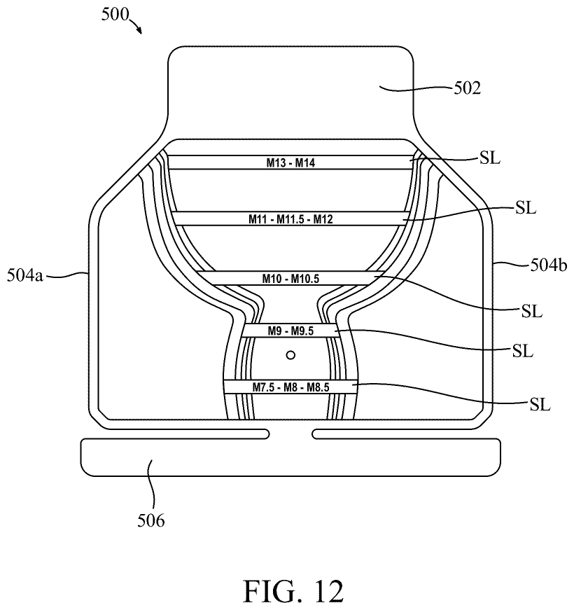

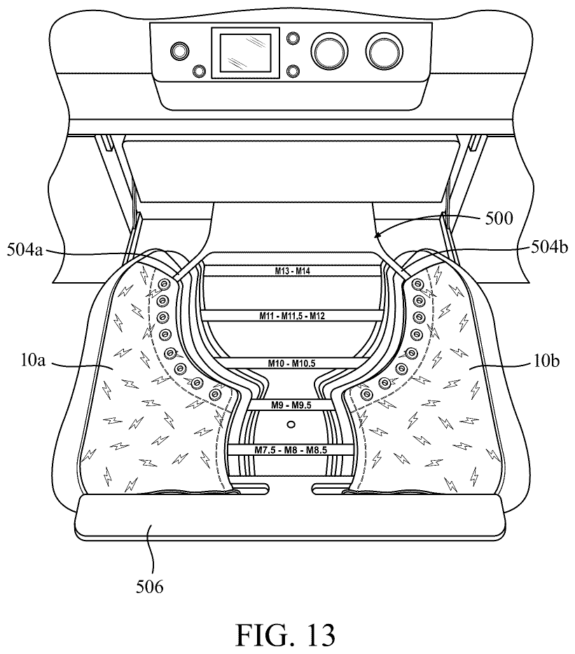

FIG. 11 is a flowchart of a set of steps that may be performed by a system such as the system (400) of FIG. 10 to determine and register the position and orientation of an article, such as the shoe (10). The system may receive (410) work surface image data captured by a camera or other imaging device (402) and may perform a machine vision function to identify (412) eyelets or other pre-configured visual characteristics within the image data. This may include identifying optical eyelet plugs (410) based upon identification of the optical element(s) or may include identification of other distinct features based upon an appropriately configured artificial intelligence or expert module. The system may determine (414) the article or garment type based upon information associated with the print job and based upon the known garment type (414) and the identified positions of eyelets or other characteristics (412), the system may determine (416) the garment's orientation on the work surface and position (418) on the work surface.

As an example, the system will be preconfigured with information describing the number and arrangement of eyelets or other characteristics for each known garment type. By capturing an image of the article and identifying the eyelets or other characteristics within that image, and comparing those identified characteristics to those expected, the system will be able to determine the articles position and orientation within the field of view, and based upon a fixed or known field of view relative to the work surface, will be able to determine the articles position and orientation on the work surface. As further example, where each eyelet is covered by an eyelet plug of known shape and size, those plugs may appear of varying sizes based on distance from the camera, and may appear as varying shapes based on orientation relative to the camera (e.g., circular when straight on, or elliptical when rotated along the x or y axis relative to the camera). Beyond individual analysis, a set of eyelet plugs in sequence and relative to each other is a strong indicator of position and orientation (e.g., with reference to FIG. 10, it can be seen that the upper lace eyelets provide a gradual curve while the two lower eyelets provide a straight line—preconfigured values for each garment type and size may be configured to describe this curve and line, and the distance between each discrete point, which will predictably change based upon the garments position and orientation relative to the camera).

Once the garment's orientation and position have been determined (416, 418) as described above, the system may determine if the position and orientation are usable (420) for the scheduled print job. Where they are usable (420), the system may update the DTG printer (104) configuration and/or build path to register the garment's current position and orientation within the work area. Where they are not usable (420), the system may provide (424) a reposition alert indicating that the print job cannot begin based on the garment's current position and orientation, and that may also indicate the proper position and/or other adjustment required before the article can be registered and the print job can begin.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present disclosure, further adaptations of the methods and systems described herein may be accomplished by appropriate modifications by one of ordinary skill in the art without departing from the scope of the present disclosure. Several such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present disclosure should be considered in terms of the following claims and is understood not to be limited to the details of structure and operation shown and described in the specification and drawings.

What is claimed is:

1. A system for enabling direct-to-garment printing of irregularly shaped articles comprising:
a. one or more user devices
b. one or more direct-to-garment printers;
c. a management server configured to:
i. provide a plurality of interfaces and features to one or more user devices;
ii. manage, update, and access one or more data libraries including a design library, a job library, an image library, and a print library; and
iii. communicate with one or more user devices and one or more direct-to-garment printers.

2. The system of claim 1 further comprising one or more cover devices configured to securely cover one or more non-printable portions of an irregularly shaped article.

3. The system of claim 1 further comprising one or more eyelet plugs configured to securely fit into one or more eyelets of an irregularly shaped article.

4. The system of claim 3 wherein the one or more eyelet plugs further comprise one or more flexible tabs configured to compress and pass through the one or more eyelets, whereby the one or more flexible tabs expand to their original shape to securely hold the one or more eyelet plugs within the one or more eyelets until a substantial force is used to remove the one or more eyelet plugs.

5. The system of claim 1 further comprising one or more platens configured to stretch an irregularly shaped article such that the irregularly shaped article has a flat and regular print surface.

6. The system of claim 5 wherein the one or more platens further comprise one or more eyelet holes that pass through the body of the one or more platens wherein the size, position, and number of the one or more eyelet holes correspond to a size, position, and number of eyelets of the corresponding irregularly shaped article.

7. The system of claim 6 further comprising one or more eyelet plugs configured to securely fasten the one or more platens to the irregularly shaped article by passing through the eyelet holes in the body of the one or more platens and the corresponding eyelets of the irregularly shaped article.

8. The system of claim 7 wherein the plurality of interfaces and features are further configured to display the printing limitations of a selected direct-to-garment printer.

9. The system of claim 1 wherein the management server is further configured to:
a. record and serialize a user design;
b. prepare a print dataset including the serialized user design; and
c. select a direct-to-garment printer from the one or more direct-to-garment printers.

10. The system of claim 1 wherein the plurality of interfaces and features include a design interface configured to allow a custom design creation for an irregularly shaped article.

11. A system for enabling direct-to-garment printing of an irregularly shaped article comprising:
a. one or more direct-to-garment printers;
b. one or more platens with one or more eyelet holes passing through a body of the one or more platens wherein the size, position, and number of the one or more eyelet holes correspond to the size, position, and number of eyelets of a corresponding irregularly shaped article, and wherein the one or more platens are configured to stretch the irregularly shaped article such that the irregularly shaped article has a flat and regular print surface;
c. an imaging device configured to produce one or more image datasets indicating a position of the irregularly shaped article; and
d. a management server configured to:
i. receive one or more image datasets associated with the imaging device;
ii. determine and register the position and orientation of the irregularly shaped article based on the one or more image datasets; and
iii. produce a build path for the one or more direct-to-garment printers such that one or more direct-to-garment printers can accurately print onto the irregularly shaped article.

12. The system of claim 11 wherein the management server is further configured to manage, update, and access one or more data libraries including a design library, a job library, an image library, and a print library.

13. The system of claim 11 wherein the management server is further configured to determine if the position and orientation of the irregularly shaped article are usable for a scheduled print job.

14. The system of claim 13 wherein the management server is further configured to send a reposition alert if the position or orientation of the irregularly shaped article is not usable for the scheduled print job.

15. The system of claim 13 wherein the management server is further configured to update and send an updated build path to the one or more direct-to-garment printers if the position and orientation of the irregularly shaped article are usable.

16. The system of claim 11 further comprising one or more optical eyelet plugs comprising a front portion having an optical element configured to securely fit into the eyelets of the irregularly shaped article.

17. The system of claim 16 wherein the imaging device is further configured to produce the one or more image datasets based on the position of the one or more optical eyelet plugs.

18. The system of claim 16 wherein the one or more optical eyelet plugs further comprise one or more flexible tabs configured to compress and pass through one or more eyelets, whereby the one or more flexible tabs expands to its original shape and securely holds the one or more optical eyelet plugs within the one or more eyelets until a substantial force is used to remove the one or more optical eyelet plugs.

19. The system of claim 11 further comprising one or more cover devices configured to securely stretch over and cover one or more non-printable portions of the irregularly shaped article.

20. A method of direct-to-garment printing of an irregularly shaped article, the method comprising:
a. receiving one or more correlated image datasets;
b. identifying optical characteristics wherein the optical characteristics are associated with the irregularly shaped article;
c. determining a type of irregularly shaped article based on the optical characteristics;
d. determining an orientation of the irregularly shaped article relative to a viewed point based on the image datasets;
e. determining a position of the irregularly shaped article relative to the viewed point based on the image datasets;
f. determining if the orientation and position of the irregularly shaped article are usable; and
g. providing a build path for a direct-to-garment printer such that the direct-to-garment printer prints on a desired area of the irregularly shaped article.
